(19) United States
(12) Patent Application Publication
(10) Pub. No.: US 2018/0234901 A1
(43) Pub. Date: Aug. 16, 2018

(54) APPARATUS FOR PERFORMING HANDOFF IN WIRELESS COMMUNICATION SYSTEM AND METHOD THEREFOR

(71) Applicants: Samsung Electronics Co., Ltd., Gyeonggi-do (KR); SNU R&DB Foundation, Seoul (KR)

(72) Inventors: Kyung Joo SUH, Seoul (KR); Wha Sook JEON, Seoul (KR); Dwijaksara MADE HARTA, Seoul (KR); Hyun Seob OH, Seoul (KR); Min Sik HWANG, Seoul (KR)

(73) Assignees: Samsung Electronics Co., Ltd.; SNU R&DB Foundation

(21) Appl. No.: 15/894,173

(22) Filed: Feb. 12, 2018

(30) Foreign Application Priority Data
Feb. 14, 2017 (KR) 10-2017-0020123

(51) Int. Cl. H04W 36/08; H04W 36/32

(52) U.S. Cl. CPC H04W 36/08; H04W 36/32

(57) ABSTRACT

An electronic device is disclosed and includes a communication circuit configured to transmit and receive a signal, a processor, and a memory configured to be electrically connected with the processor. The processor is configured to allow the communication circuit to receive data for a handoff from a server, determine a target access point (AP) of a connection after the handoff among candidate target APs based on the data for the handoff, and determine a handoff trigger point based on the data for the handoff and trigger a handoff to the target AP if a position of the electronic device meets the determined handoff trigger point.

### PRIORITY

This application claims priority under 35 U.S.C. § 119(a) to Korean Patent Application Serial No. 10-2017-0020123, which was filed in the Korean Intellectual Property Office on Feb. 14, 2017, the entire content of which is incorporated herein by reference.

### BACKGROUND

### 1. Field of the Disclosure

The present disclosure relates to an apparatus and method for performing a handoff of a networked electronic device between a first access point and a second access point.

### 2. Description of Related Art

With the recent advancement of information communication technologies, a variety of wireless communication technologies have been developed. Current research is in communication technologies for implementing a connected car or an autonomous driving car, and may be the core of the future for the car industry.

It is necessary to perform a fast handoff between access points (APs) along a vehicle's moving path to smoothly transmit and receive data through wireless local area network (WLAN) communication. A layer 2 (L2) handoff in which a specific AP is handed off to an adjacent AP which belongs to the same subnet may be performed in an order of 1) triggering, 2) channel scan, 3) selection, 4) reauthentication, and 5) reassociation. In case of a layer 3 (L3) handoff in which the specific AP is handed off to an AP which belongs to another subnet, it takes a long time due to the specific AP needs to be reassigned an Internet protocol (IP) address from a dynamic host configuration protocol (DHCP) server. A channel scan interval of an L2 and an IP address assignment interval of an L3 may occupy a considerable time in the L2 to L3 handoff processes.

According to a conventional handoff procedure, an electronic device may request from an AP connected to the electronic device that the AP transmit information about peripheral APs around the electronic device. The AP may transmit the information about the peripheral APs to the electronic device. The electronic device may update position information of the electronic device. While the electronic device moves on a moving path, it may determine a candidate AP and may scan a channel in a priority order for each of the candidate APs. The electronic device may determine a target AP based on the result of scanning the channel and may perform a handoff to the target AP. After performing the handoff, the electronic device may repeat the procedures.

It may take around 2.4 to 4.2 seconds for the L2 handoff and the L3 handoff to complete, and data transmission and reception may not be possible during this time. In an electronic device which frequently performs a handoff according to its fast movement, data transmission and reception efficiency may be seriously degraded. To enhance data transmission and reception efficiency, the number of unnecessary handoffs should be reduced and a time taken to perform a handoff should be reduced.

In the related art, if a connection with an AP is unstable, a handoff may be triggered. If a connection with an AP is stable although an electronic device enters a service area of another AP which provides a better quality of service, a handoff may not be performed therefore data transmission and reception efficiency may be degraded even though the handoff is performed at a necessary time.

### SUMMARY

Aspects of the present disclosure are to address at least the above-mentioned problems and/or disadvantages, and to provide at least the advantages described below. Accordingly, an aspect of the present disclosure is to provide a method for obtaining data necessary for a handoff based on crowdsourcing and performing the handoff based on the obtained data at an electronic device.

In accordance with an aspect of the present disclosure, an electronic device is provided. The electronic device includes a communication circuit configured to transmit and receive a signal, a processor, and a memory configured to be electrically connected with the processor. The processor is configured to allow the communication circuit to receive data for a handoff from a server; determine a target AP to connect with after the handoff among candidate target APs based on the data for the handoff; and determine a handoff trigger point based on the data for the handoff and trigger a handoff to the target AP if a position of the electronic device meets the determined handoff trigger point requirements.

In accordance with another aspect of the present disclosure, a server is provided. The server includes a communication circuit configured to transmit and receive a signal; a processor; and a storage. The processor allows the communication circuit to receive a result of scanning a channel for a peripheral AP around an electronic device and moving path data of the electronic device from the electronic device; receive a data request for a handoff from the electronic device; and transmit data for the handoff, including at least one of channel model information about the peripheral AP around the electronic device or a moving direction probability for the electronic device, to the electronic device in response to a request of the handoff.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an operation of an electronic device according to an embodiment of the present disclosure;

FIG. 2 illustrates a network environment for various embodiments of the present disclosure;

FIG. 3 is a block diagram illustrating a configuration of an electronic device and a configuration of a server according to an embodiment of the present disclosure;

FIG. 4 is a functional block diagram illustrating a function of a server according to an embodiment of the present disclosure;

FIG. 5 is a signal sequence diagram illustrating a method for obtaining data for a handoff of an electronic device according to an embodiment of the present disclosure;

FIG. 6 is a flowchart illustrating a method for performing a handoff in an electronic device according to an embodiment of the present disclosure;

FIG. 7 illustrates a road region according to an embodiment of the present disclosure;

FIG. 8 is a table illustrating a pathloss model applicable to an embodiment of the present disclosure; and

FIG. 9 illustrates a handoff effect according to an embodiment of the present disclosure.

Throughout the drawings, it should be noted that like reference numbers may be used to depict the same or similar elements, features, and structures.

### DETAILED DESCRIPTION

Those of ordinary skill in the art will recognize that modifications, equivalents, and/or alternatives on the various embodiments of the present disclosure described herein can be made without departing from the scope and spirit of the present disclosure. In this disclosure, the expressions “have”, “may have”, “include”, “comprise”, “may include”, and “may comprise” used herein indicate existence of corresponding features (e.g., elements such as numeric values, functions, operations, or components) but do not exclude the presence of additional features.

In this disclosure, the expressions “A or B”, “at least one of A and/or B”, or “one or more of A and/or B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

Terms, such as “first”, “second”, and the like used in this disclosure may be used to refer to various elements regardless of the order and/or the priority, and to distinguish the relevant elements from other elements, but do not limit the elements. For example, “a first user device” and “a second user device” indicate different user devices regardless of the order or priority. For example, without departing from the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

The expression “configured to” used in this present disclosure may be used interchangeably with the expressions “suitable for”, “having the capacity to”, “designed to”, “adapted to”, “made to”, or “capable of”. The term “configured to” does not mean only “specifically designed to” in hardware. Instead, the expression “a device configured to” may mean that the device is “capable of” operating together with another device or other components. For example, a “processor configured to or set to perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in this disclosure are used to describe specific embodiments of the present disclosure and are not intended to limit the scope of another embodiment of the present disclosure. The terms of a singular form may include plural forms unless otherwise specified. All terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of this disclosure. In some cases, even if terms are defined in this disclosure, they may not be interpreted to exclude embodiments of this disclosure.

An electronic device according to various embodiments of this disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), motion picture experts group (MPEG-1 or MPEG-2) audio layer 3 (MP3) players, mobile medical devices, cameras, or wearable devices. The wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or a bio-implantable type (e.g., an implantable circuit).

According to various embodiments of the present disclosure, the electronic device may be a home appliance. The home appliances may include at least one of, for example, televisions (TVs), digital versatile disc (DVD) players, audio players, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, and the like.

According to an embodiment of the present disclosure, an electronic device may include at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, global navigation satellite system (GNSS), global positioning system (GPS), event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller machines (ATMs), points of sale (POS) devices, or Internet of things (IoT) devices (e.g., light bulbs, various sensors, electric or gas meters, sprinkler devices, fire alarms, thermostats, street lamps, toasters, exercise equipment, hot water tanks, heaters, boilers, and the like). Hereinafter, in this disclosure, the term “GPS” may be interchangeably used with the term “GNSS”.

According to an embodiment of the present disclosure, the electronic device may include at least one of parts of furniture or buildings/structures, electronic boards, electronic signature receiving devices, projectors, or various measuring instruments (e.g., water meters, electricity meters, gas meters, or wave meters, and the like). The electronic device may be one of the above-described devices or a combination thereof. An electronic device may be a flexible electronic device. Furthermore, an electronic device may not be limited to the above-described electronic devices and may include other electronic devices and new electronic devices according to the development of new technologies.

In this disclosure, the term “user” may refer to a person who uses an electronic device or may refer to a device (e.g., an artificial intelligence electronic device) that uses the electronic device.

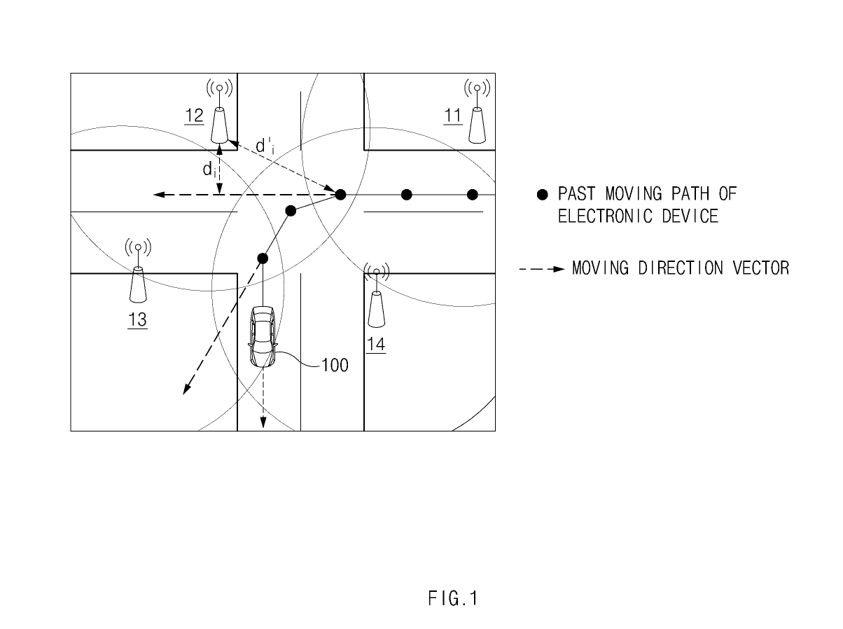

FIG. 1 illustrates an operation of an electronic device according to an embodiment of the present disclosure.

Referring to FIG. 1, an electronic device 100 may perform a handoff using a GPS mounted in the electronic device 100, and a database (DB) which stores position and operation channel information of an AP.

The electronic device 100 connected to an AP 11 may estimate a moving direction based on a position of the electronic device 100 and may calculate a priority order for each of APs 12 to 14 located on an expected moving path. After triggering a handoff, the electronic device 100 may sequentially scan channels from an operation channel of an AP having a high priority order. Herein, an AP which is a target to which the electronic device 100 is handed off may be referred to as a target AP.

The electronic device 100 may obtain information associated with an operation channel of an AP (e.g., the AP 12) from its DB. If a channel of the AP is idle, the electronic device 100 may scan a channel of an AP (e.g., the AP 13) with the next priority order. If retransmission of a link-layer frame fails 3 times consecutively, the electronic device 100 may trigger a handoff. According to this manner, the time required for a channel scan process which occupies a substantial portion of the time required for an L2 handoff may be greatly reduced. The electronic device 100 may primarily scan only channels operated by the peripheral APs 12 to 14 without scanning all channels to considerably reduce a time due to an unnecessary scan. Herein, such a manner may be effective if priority orders for the handoff candidate target APs 12 to 14 are accurately calculated.

According to an embodiment of the present disclosure, the electronic device 100 may determine a future trajectory having the highest probability based on a trajectory history of the electronic device 100 and accumulation data of a received signal strength (e.g., received signal strength indicator (RSSI)). The electronic device 100 may previously determine an optimum handoff trigger point using accumulation data of an RSSI value.

If the electronic device 100 determines a handoff target AP with respect to an RSSI value, target APs to which the electronic device 100 may be handed off at a current location of the electronic device 100 may greatly vary in number according to an RSSI reference value. For example, if an RSSI reference value for a handoff is high, since there is a high probability that the electronic device 100 will perform a handoff to an AP (e.g., the AP 12 or 14) near the electronic device 100, a service area of which is greatly overlapped with an AP (e.g., the AP 11) currently connected to the electronic device 100, the number of handoffs may be increased.

A unique cost function may be designed by reflecting a tradeoff between the number of handoffs and an RSSI value in consideration of such a characteristic. The electronic device 100 may calculate a cost for handoff trigger points to which a handoff may be performed based on an RSSI value in a future trajectory, for example, zones, service areas of which are overlapped with each other between adjacent APs, and may determine a handoff target AP having the lowest cost and a handoff trigger point. If a trajectory history for a zone where a handoff is performed and accumulation data are sufficient, the above-mentioned handoff may be performed.

As described above since a method of assigning a priority order to APs based on estimation of a moving direction is incorrect, an error may be generated. According to an embodiment of the present disclosure described with reference to FIG. 1, a time required to additionally scan a channel may be rapidly increased and a time required for a handoff may be increased causing reduced data transmission and reception efficiency. In reference to FIG. 1, there may be a need for sufficiently accumulating a trajectory history and data of an RSSI. To apply the handoff method to a general road, since trajectory histories and data of RSSI(s) for all roads should be accumulated, it may be difficult to widely apply the described handoff method to a general road.

In FIG. 1, the electronic device 100 may perform a handoff based on trajectory history data of the electronic device 100. Although a lot of data is needed because of a data-based handoff, since data use is limited to the data of the electronic device 100, it may be difficult to obtain the required data.

In an embodiment of the present disclosure, database construction and a handoff based on crowdsourcing is provided. An electronic device 1) may obtain data necessary for a handoff based on crowdsourcing, 2) may determine a handoff target AP and an expected handoff trigger point based on the obtained data, 3) may perform a handoff to the target AP, and 4) may construct a database necessary for the handoff in a server.

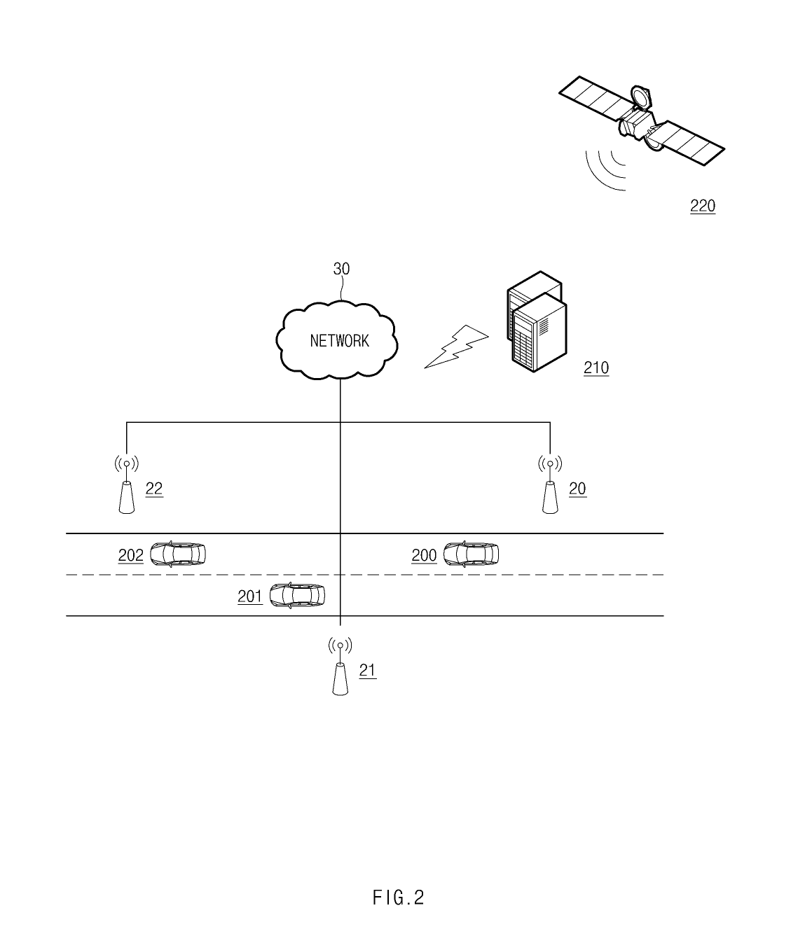

FIG. 2 illustrates a network environment for various embodiments of the present disclosure.

Referring to FIG. 2, the network environment may include an electronic device 200, an AP 20, a server 210, and a GPS satellite 220. In a situation where the moving electronic device 200 is connected to the AP 20 for data communication, the electronic device 200 may continuously and quickly perform a handoff to APs 20 to 22 which exist around a road to maintain a smooth connection state.

In an embodiment of the present disclosure, the electronic device may perform WLAN communication and/or vehicle to everything (V2X) communication. The WLAN communication may comply with a WLAN related communication protocol described in an IEEE 802.11 related standard document. Hereinafter, the WLAN communication may be referred to as wireless-fidelity (Wi-Fi). The WLAN related communication protocol may support V2X communication.

V2X communication may include vehicle to vehicle (V2V) communication, vehicle to infrastructure (V2I) communication, and vehicle to nomadic device (V2N) communication.

V2I is a communication technology where a vehicle which supports V2X and an infrastructure, such as a device which performs data communication that is installed on a road, may exchange traffic context information, such as a traffic accident and the volume of traffic, in real time. In an embodiment of the present disclosure, a vehicle may be referred to as an electronic device, and a device which performs a variety of network communication which are applicable in the present disclosure with a vehicle may be referred to as an AP or a WLAN AP. Each of the first electronic device 200, a second electronic device 201, and a third electronic device 202 may perform V2I communication with a first AP 20, a second AP 21, or a third AP 22. Each of the first electronic device 200, the second electronic device 201, and the third electronic device 202 may be a vehicle, or a device mounted or embedded in the vehicle.

A network applied to various embodiments in the present disclosure may be WLAN communication, V2X defined in a WLAN communication protocol, or a V2X communication network defined in various communication protocols such as IEEE1609.x, IEEE802.11p, SAEJ2945, 3GPP 36.211, and 3GPP 36.212.

In an embodiment of the present disclosure, at least one of the first electronic device 200, the second electronic device 201, and the third electronic device 202 may communicate with the first AP 20, the second AP 21, and the third AP 22 connected to a network 30. At least one of the first electronic device 200, the second electronic device 201, and the third electronic device 202 may transmit and receive a signal with the server 210 over the first AP 20, the second AP 21, and the third AP 22 connected to the network 30.

While performing communication in a state where the first electronic device 200 is connected to the first AP 20, the electronic device 200 may move, for example when located in a vehicle, on a road and may perform a handoff. Contrary to a conventional RSSI-based handoff, the electronic device 200 may perform a handoff based on data collected from an electronic device (e.g., the second electronic device 201 or the third electronic device 202) which was previously located at a corresponding position, based on crowdsourcing.

The first to third electronic devices 200 to 202 may perform data communication during driving and may transmit data to the server 210. For example, the first to third electronic devices 200 to 202 may transmit lane change data and data about the result of performing a handoff.

The server 210 may calculate data necessary for determining a handoff trigger point for the first electronic device 200 and a handoff target WLAN AP based on the received data. If a request from the first electronic device 200 is received, the server 200 may transmit the data to the first electronic device 200.

The first electronic device 200 may perform a handoff based on information received from the server 210. For example, the first electronic device 200 may perform a handoff to the second AP 21.

In an embodiment of the present disclosure, the first electronic device 200 may obtain position information from the GPS 220. The first electronic device 200 may transmit a variety of information, such as position information, to the server 210. The first electronic device 200 may obtain data for a handoff via the first AP 20 connected to the network 30 before the handoff from the server 210. If the handoff to the second AP 21 is successful, the first electronic device 200 may transmit the result of performing the handoff to the server 210 via the second AP 21.

In FIG. 2, in an embodiment of the present disclosure, the position information is obtained from the GPS 220. However, an electronic device may obtain position information based on other position systems. For example, the electronic device may obtain position information based on long term evolution (LTE) communication and Wi-Fi communication.

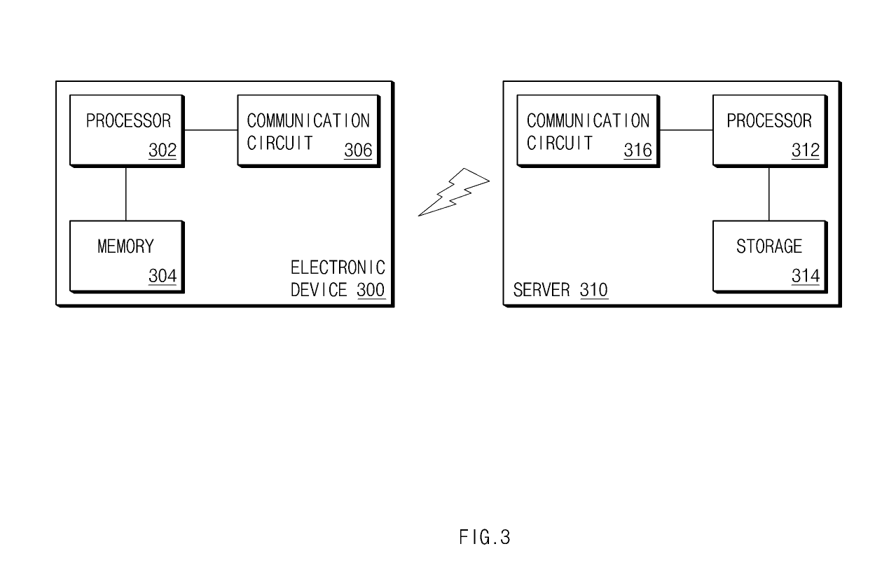

FIG. 3 is a block diagram illustrating a configuration of an electronic device and a configuration of a server according to an embodiment of the present disclosure.

Referring to FIG. 3, the communication system according to an embodiment of the present disclosure may include an electronic device 300 and a server 310.

The electronic device 300 may include a processor 302, a memory 304, and a communication circuit 306.

The processor 302 may perform various embodiments of the present disclosure and may control another element (e.g., the communication circuit 306). The processor 302 may scan channels for peripheral APs around the electronic device 300. The processor 302 may determine a target AP for performing a handoff and a handoff trigger point using information which is received via the communication circuit 306 or is extracted from the memory 304. The processor 302 may request the server 310 and/or a GPS to transmit data necessary for a handoff.

The processor 302 may control the communication circuit 306 to transmit and receive a signal with the server 310, the GPS, or an AP.

The processor 302 may manage information stored in the memory 304. The memory 304 may store the result of scanning the peripheral AP around the electronic device 300, information received from the server 310, or the like.

The server 310 may include a processor 312, a storage 314, and a communication circuit 316.

The processor 312 may perform various embodiments of the present disclosure and may control another element. The processor 312 may receive data from the electronic device 300 or may transmit data to the electronic device 300, via the communication circuit 316. The processor 312 may determine data to be transmitted to the electronic device 300, based on a signal received from the electronic device 300. The processor 312 may receive the result of scanning a channel for a peripheral AP around the electronic device 300 and moving path data of the electronic device 300. The processor 312 may receive a request to transmit data for a handoff from the electronic device 300. The processor 312 may transmit data for a handoff, including at least one of channel model information for a peripheral AP around the electronic device 300 or a moving direction probability for the electronic device 300, to the electronic device 300 in response to the request for the handoff. The data for the handoff may be data generated based on data previously received at the server 310 from the electronic device 300 or another electronic device. The processor 312 may transmit information, extracted from the storage 314, to the electronic device 300. The processor 312 may manage information stored in the storage 314 based on a signal received from the electronic device 300.

The storage 314 may develop or update a moving path probability DB or a channel model based on RSSI(s) of an AP or moving path data, which are collected from electronic devices, such as the electronic device 300. The channel model may be a signal processing model in a wireless interface interval. Theory, collected channel measurement information, and the like may be used to implement the channel model. The server 310 according to an embodiment of the present disclosure may construct the channel model by mathematically calculating channel characteristics of various APs and establishing a parameter indicating a channel characteristic for each AP, an index of a pathloss model, and the like. The electronic device 300 may determine a target AP by obtaining data for a handoff in advance from the server 310 and may perform the handoff by calculating a handoff time.

The following procedure may be performed to perform a handoff according to an embodiment of the present disclosure. In operation (a), the electronic device may obtain data for a handoff from the server based on its current position. In operation (b), the electronic device may select a handoff target AP based on the information obtained in operation (a) and may calculate a handoff trigger point to the target AP. Operation (b) may be referred to as a handoff preparation operation. In operation (c), the electronic device may perform a handoff to the target AP at the handoff trigger point determined in operation (b). In operation (d), the electronic device may transmit the result of performing the handoff to the server. The server may update information for the handoff.

To perform the above-mentioned handoff procedure, in operation (a), information provided to electronic devices may be previously stored in the server. For example, data, such as road information and information about a WLAN AP, pre-configured by the server and/or data previously generated by the server may be provided to the electronic devices.

Herein, a description will be given of a method for generating or managing data necessary for proceeding with a handoff and data at the server or the electronic device.

1. Data Necessary for Proceeding with the Handoff and the Method for Generating and Managing the Data

1-1. The Data Necessary for Proceeding with the Handoff

An electronic device (e.g., an electronic device 300) and/or a server (e.g., a server 400) may store the following data for a fast handoff. The electronic device and/or the server may store:

i) fixed data which is provided from an operator which operates a WLAN and is previously input to the server (e.g., data pre-configured in the server),

ii) data reported to the server by the electronic device which collects crowdsourcing data,

iii) data about the result of performing a handoff, reported to the server by a user device which performs the handoff, and

iv) data transmitted to the electronic device by the server.

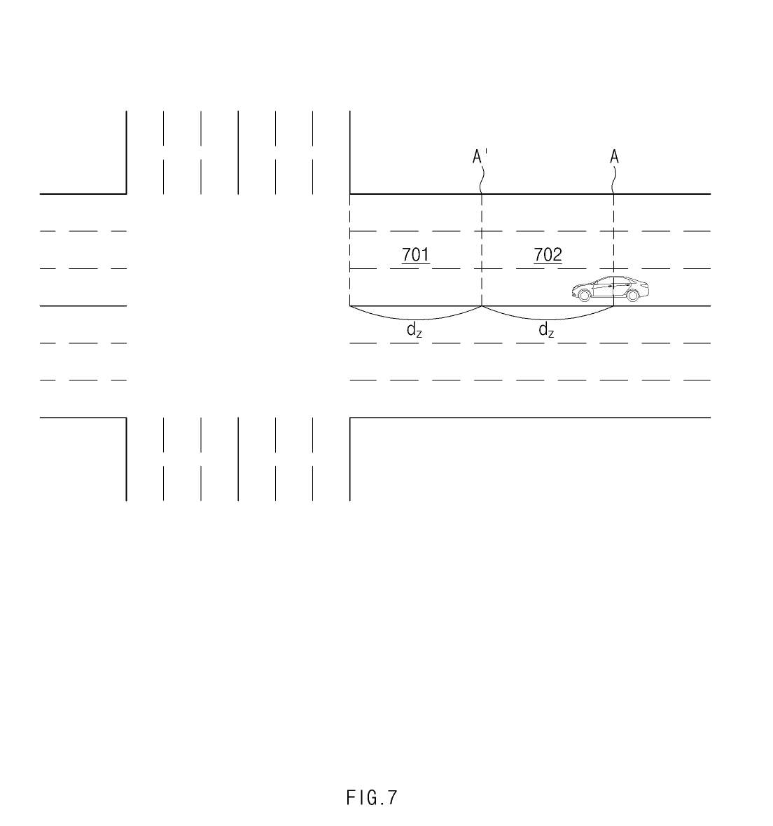

The fixed data of i) may include road information including at least one of a road type, a position, an azimuth angle, the number of lanes, a movable direction (e.g., a left turn, a right turn, going straight, a U-turn, or the like), and road zone information and WLAN AP information including at least one of a basic service set identifier (BSSID), a service set identifier (SSID), an IP address, an operation channel, and a position (e.g., a GPS coordinate). In an embodiment of the present disclosure, the road zone information may be a concept used to predict a moving direction based on a moving path of a vehicle. The road zone information may refer to a description about FIG. 7.

The data of ii) may include signal strength of a peripheral WLAN AP, measured at a position during driving, measured position information (e.g., a GPS coordinate), or at least one of a lane change history during driving and a moving direction at an intersection.

The data about the result of performing the handoff in iii) may include at least one of lane change history, a moving direction, a handoff operation time, information about an AP connected before a handoff, or information about a target AP.

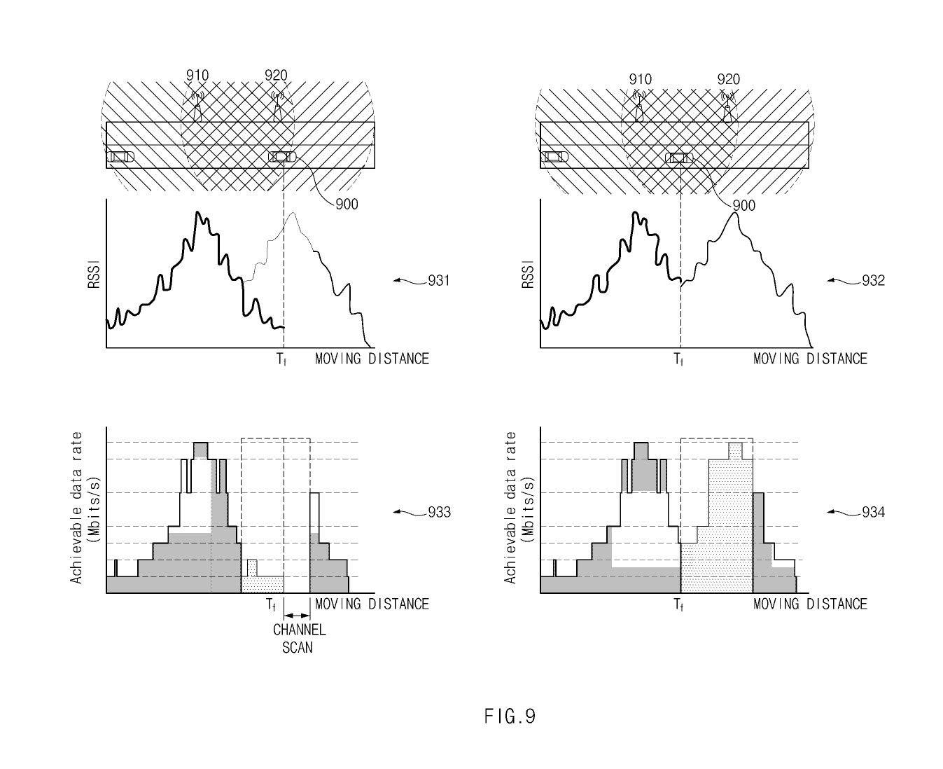

The data of iv) may include at least one of channel model information or data for predicting a handoff target AP. The server may develop a wireless channel model using the data of ii) obtained from the electronic device such that the electronic device calculates a handoff trigger point. The server may include a channel model which is applicable to each AP of a corresponding zone based on RSSI measurement data obtained from electronic devices. The data for predicting the handoff target AP may include at least one of a probability that an electronic device will move from a lane of a zone when the electronic device is currently located to each lane of a next zone, a moving direction probability in case of an intersection, and a handoff time expected value for each WLAN AP. A channel model which is applicable to various embodiments of the present disclosure may be referred to as a channel, as described in FIG. 9 below.

The following is a relationship between data. The server may develop a wireless is channel model using road information and WLAN AP information, which are fixed data, and RSSI information according to a distance from each AP, collected from electronic devices. Channel model information may include at least one of a pathloss model, parameter values according to the pathloss model, and an average and standard deviation of random variables modeling padding.

The electronic device may determine a handoff trigger point based on its current position without scanning a peripheral AP channel around the electronic device using model information received from the server.

According to an embodiment of the present disclosure, since data is collected based on crowdsourcing, large amounts of data may be collected in a relatively short time. As more data is collected, a channel model may become more and more sophisticated. An urban channel model of a WLAN developed by conventional research may be applied in an initial stage where RSSI measurement data is not accumulated enough data to develop a channel model.

Since data about a lane change history and a moving direction is collected from an electronic device which is being driven or an electronic device in a vehicle based on crowdsourcing, data may be accumulated within a short time. The server may initially apply data from a similar road.

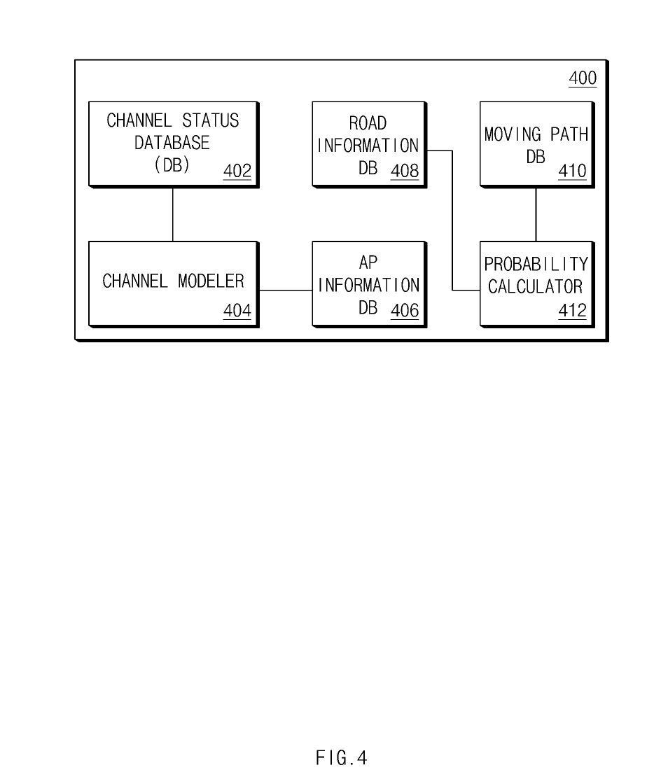

FIG. 4 is a functional block diagram illustrating a function of a server according to an embodiment of the present disclosure.

With reference to FIG. 4, a description will be given for a data processing operation between a server 400 and an electronic device. The server 400 may include at least one of a channel status DB 402, a channel modeler 404, an AP information DB 406, a road information DB 408, a moving path DB 410, and a probability calculator 412. In an embodiment of the present disclosure, an operation performed by each element may be performed or controlled by a processor 312. Each element may correspond to the processor 312 or a storage 314.

The server 400 may develop a wireless channel model and/or a moving direction probability using at least one of information from i) to iii) or at least one of information included in each of the data information described above with regards to i) to iii).

In an embodiment of the present disclosure, an electronic device (e.g., a second electronic device 201) may transmit RSSI information and/or moving path data to the server 400. The electronic device may perform a report to the server 400 at a period of Tᵤ.

In an embodiment of the present disclosure, the server 400 may receive a collected RSSI report from the electronic device (e.g., the second electronic device 201). The server 400 may store the received information in the channel status DB 402. The server 400 may develop a wireless channel model based on data stored in the channel status DB 402 and WLAN AP information previously input to the AP information DB 406. The channel modeler 404 may develop and/or update a wireless channel model for each AP and may store the developed and/or updated wireless channel model again in the AP information DB 406.

In an embodiment of the present disclosure, moving path data of the electronic device may be used to predict a moving path based on a lane. The electronic device may report the moving path data to the server 400. The server 400 may store and accumulate the reported data in the moving path DB 410. The probability calculator 412 may calculate and/or update a moving direction probability based on data of road information previously input to the moving path DB 410 and the road information DB 408. The server 400 may store the calculated or updated moving direction probability in the road information DB 408.

The electronic device may request the server 400 to transmit data for a handoff. The request to transmit the data may include a coordinate and a radius of the electronic device.

The server 400 may transmit the data for the handoff to the electronic device. The server 400 may transmit AP information and/or channel information to the electronic device.

The electronic device may obtain moving path data from a position system such as a GPS or a cellular system. The position system may update a position coordinate along a trajectory in which the electronic device moves.

Table 1 indicates an example of a report scheme for information exchanged between the electronic device, the server 400, and/or a position system.

TABLE 1

| Data | Description |
|---|---|
| Channel | RSSI, BSSID, SSID, Distance |
| status | |
| Moving path | Intersection ID, direction, k zone₁: Lane, . . . , Zoneₘ: Lane |
| Road | Road start/end coordinates, road azimuth, curved point |
| information | coordinates, conditional probability |
| Information | Position coordinate of user, radius |
| requests | |
| AP | BSSID, SSID, Channel, Position coordinate, transmit |
| information | power, IP address, Subnet info, average handoff |
| & channel | operation time Pathloss model index, Pathloss para- |
| information | meters, mean and std. of lognormal dist. |
| Position | Latitude, Longitude |
| coordinate | |

Hereinafter, a description will be given in detail of an embodiment of the present disclosure generating and managing data at the server 400 and/or the electronic device.

1-2. Method for Generating and Managing Data 1-2-1. Method for Obtaining and Transmitting Road Information and Information about an Installed WLAN AP

The road information associated with information of i) and the information about the installed WLAN AP may be input to a server by a network operator who operates a WLAN network. Basic information such as an installation position and an operation u) channel of the WLAN AP, and information about the road on which the WLAN AP is installed may be information that is not frequently changed. When a user requests to the server to transmit information previously input by the operator of the WLAN network, the server may transmit the information to the electronic device. The electronic device may recognize information corresponding to the data information of i) above.

1-2-2. Method for Obtaining and Transmitting Data Transmitted to the Server at the Electronic Device

The electronic device may obtain information corresponding to data information of ii) or iii), and may transmit the obtained information to the server. In an embodiment of the present disclosure, the electronic device may transmit RSSI measurement data and/or data about the result of performing a handoff and lane change data to the server.

1-2-2-1. RSSI Measurement Data

WLAN AP signal information reported by electronic devices is necessary to develop a wireless channel model. The electronic device may measure a signal of a peripheral WLAN AP around the electronic device at a constant measuring period Tₛ after driving is started. The electronic device may transmit the measured result to the server at a constant report period Tᵤ (herein, Tₛ≤Tᵤ).

Since the electronic device collects signal strength during its movement, a measurement position may vary for each wireless channel. For example, according to specific criteria (e.g., 2.4 GHz, 5 GHz 32 channels, active scan dwell time 80 ms) in which it takes 2.56 seconds to scan a channel, if a 60 km/h, which is a general urban maximum driving speed, is applied, the electronic device may move about 42.8 m in 2.65 seconds while searching for a WLAN AP signal.

In general, if sequential measurement for all available channels of a wireless channel signal of the electronic device is completed, the result of corresponding measuring signal strength may be obtained. Since the electronic device continues changing location in a state where signal strength measurement is in progress while the electronic device is driven, the electronic device may measure each channel at different positions. Thus, it may be difficult for the electronic device to represent each channel as one GPS position coordinate.

To solve this, the number of channels may be limit and the electronic device may make a list of measurement channels with respect to AP channels within a specific distance radius (R km) and may measure the channels of the list. The electronic device may estimate a GPS coordinate for each channel.

A procedure of measuring an RSSI may be performed thereafter.

The electronic device may calculate a current distance between the electronic device and a peripheral AP around the electronic device based on position information of the electronic device and a wireless AP channel, and position information obtained from the server. The electronic device may obtain an operation channel list for the AP around the electronic device with respect to the calculated distance.

The electronic device may start a signal search. The electronic device may store position information (e.g., a GPS coordinate) for when the measurement is started. The electronic device may perform a signal search based on the operation channel list. The electronic device may perform a signal search from a channel with a low frequency.

If a signal search for channels is completed, the electronic device may store position information for the end point. The electronic device may divide between a search start position and a search end position by the number of measurement channels, and may estimate a position for each channel where each position may be represented as a coordinate (e.g., a GPS coordinate).

The electronic device may report to the server. The electronic device may transmit channel information, the result of measuring a signal of a corresponding channel, and measured or estimated position information to the server. The server may add the received data. The electronic device may transmit data at a report period Tᵤ (e.g., 1 minute) if it has a direct influence on a process of performing a handoff (e.g., at a time when the electronic device does not perform data communication or when it smoothly performs data communication). If data created by the electronic device is not emergency data which should be immediately reported, the electronic device may not report the data during handoff. If a report period returns during a time when the electronic device does not have a direct influence on a process of performing a handoff, the electronic device may report data collected to the server.

1-2-2-2. Data about the Result of Performing a Handoff and Lane Change Data

The data about the result of performing the handoff of an electronic device may include at least one of a lane change history in which the electronic device changes a lane, a moving direction, a handoff operation time, and target AP information. The lane change history and/or the moving direction information may be used to predict a moving path. The electronic device may use a handoff operation time to calculate an average handoff operation time of a target AP. Since the lane change history and/or the moving direction information is irrespective of the result of performing a handoff, it may be obtained from electronic devices which jointly collect crowdsourcing data if the handoff is not performed. The method for collecting the lane change history and the moving direction information at the electronic device may be performed hereafter.

A large overhead may result from tracking and storing all of consecutive moving paths of the electronic device. Thus, as shown in FIG. 7, the electronic device or the server may divide a road into several road zones to obtain data and digitalize the result. In an embodiment of the present disclosure, the electronic device or the server may represent a moving path of a vehicle as lane change information between adjacent road zones.

Table 2 is an example of a report data format sent to the server by the electronic device.

TABLE 2

| Index | Value |
|---|---|
| Road ID | rd-seoul-xx-1021 |
| Road type | Intersection |
| Moving result | Direct |
| Lane record (zone 1, zone 2, zone 3) | (2, 2, 1) |

Referring to Table 2, the report data format may include a road identifier (e.g., a road number), a road type, a moving direction in the road type, and lane information in which the electronic device stays in each road zone before entering in the direction. Table 2 illustrates data transmitted to the server at the electronic device if the electronic device which stays in a first lane on zone 3 moves to a second lane on zone 2, maintains a second lane on zone 1, and goes straight at an intersection. In this case, data transmitted according to the report data format by the electronic device may be [rd-seoul-xx-1021, intersection, direct, (2, 2, 1)].

If a report returns according to a report period Tᵤ at a time when the electronic device does not have a direct influence on a process of performing a handoff, the electronic device may report data collected to a server. For example, the electronic device may transmit an accumulated result for measuring a WLAN AP signal, a land movement result, and/or a result of performing a handoff to the server.

1-2-3. Method for Obtaining and Transmitting Data Transmitted to an Electronic Device at a Server

Only road information initially input by an operator of a WLAN network and only information about an installed WLAN AP may be initially stored in the server. Thereafter, the server may generate valid information for a next handoff based on data received from electronic devices. The valid information may be generated based on accumulated data. Hereinafter, the valid information for the handoff may be referred to as data for a handoff. Data received from electronic devices at the server may include at least one of WLAN AP signal measurement data (e.g., RSSI measurement data), a lane change history based on a road zone, a moving direction, and a result of performing a handoff. The result of performing the handoff may include at least one of an operation time, an AP connected before the handoff, and a connection target AP. The server may generate and manage data for predicting a handoff target AP and/or data for calculating a handoff point.

1-2-3-1. Data for Predicting a Handoff Target AP

The server may calculate and store an average time required to perform a handoff or an average handoff operation time between two APs, a lane change probability of two adjacent zones, and a moving direction probability at an intersection.

(1) Average Time Required to Perform a Handoff

The server may calculate an average handoff operation time between two APs based on an AP before a handoff, a handoff target AP, and/or handoff operation time information between the APs among data received from an electronic device (s).

(2) Lane Change Probability

The server may calculate a lane change probability. The server may calculate a lane change probability between adjacent zones by performing statistics processing with respect to a per-zone lane change history received from the electronic device (s) and/or moving direction data at an intersection. Herein, a description will be given in detail of a method for calculating the lane change probability.

lₘ may be a random variable indicating a lane on a zone m, and δ may be a random variable indicating a moving direction. A value indicated by δ may include ‘left’, ‘right’, ‘direct’, and ‘u-turn’ respectively corresponding to a left turn, a right turn, going straight, and a U-turn. Hereinafter, each of zone 1 and zone 2 may be a specific zone on a road and may refer to a description of FIG. 1. The server may calculate a lane movement probability Pr(lₘ₋₁=i|lₘ=k), m∈{2, . . . n_{z}} of two adjacent zones for lanes of all zones and a moving direction probability Pr(δ=x|l₁=k), x∈{left,right,direct,U-turn} using collected data.

Equation (1) illustrates a per-lane conditional probability according to movement from a first lane of zone 2 to zone 1.

Pr(l₁=1|l₂=1)=0.45, Pr(l₁=2|l₂=1)=0.2, Pr(l₁=3|l₂=1)=0.35 (1)

Equations (2) to (4) illustrate a conditional probability for each moving direction in zone 1.

Pr(δ=lef|tl₁=1)=0.9, Pr(δ=direct|l₁=1)=0.1, Pr(δ=right|l₂=1)=0.0 (2)

Pr(δ=lef|tl₁=2)=0.3, Pr(δ=direct|l₁=2)=0.5, Pr(δ=right|l₁=2)=0.2 (3)

Pr(δ=lef|tl₁=3)=0.1, Pr(δ=direct|l₁=3)=0.2, Pr(δ=right|l₁=3)=0.7 (4)

In an embodiment of the present disclosure, the server may calculate a further moving direction probability at an intersection according to whether the electronic device is located on any lane for each zone based on a lane change probability between adjacent zones and a moving direction probability at the intersection. Equations (5) to (7) illustrate a moving direction probability at an intersection if the electronic device is located on a first lane of zone 2. Equation (5) illustrates a left-turn probability. Equation (6) illustrates a direct probability. Equation (7) illustrates a right-turn probability.

$$\begin{matrix}Pr ( δ = lef \vert {tl}_{2} = 2 ) = {\sum }_{w = 1}^{3} Pr ( δ = lef \vert {tl}_{2} = w ) \cdot Pr ( {l}_{2} = w \vert {l}_{2} = 1 ) = 0.5 & ( 5 ) \\ Pr ( δ = direct \vert {l}_{2} = 1 ) = {\sum }_{w = 1}^{3} Pr ( δ = direct \vert {l}_{2} = w ) \cdot Pr ( {l}_{2} = w \vert {l}_{2} = 1 ) = 0.2150 & ( 6 ) \\ Pr ( δ = right \vert {l}_{2} = 1 ) = {\sum }_{w = 1}^{3} Pr ( δ = right \vert {l}_{2} = w ) \cdot Pr ( {l}_{2} = w \vert {l}_{2} = 1 ) = 0.2850 & ( 7 )\end{matrix}$$

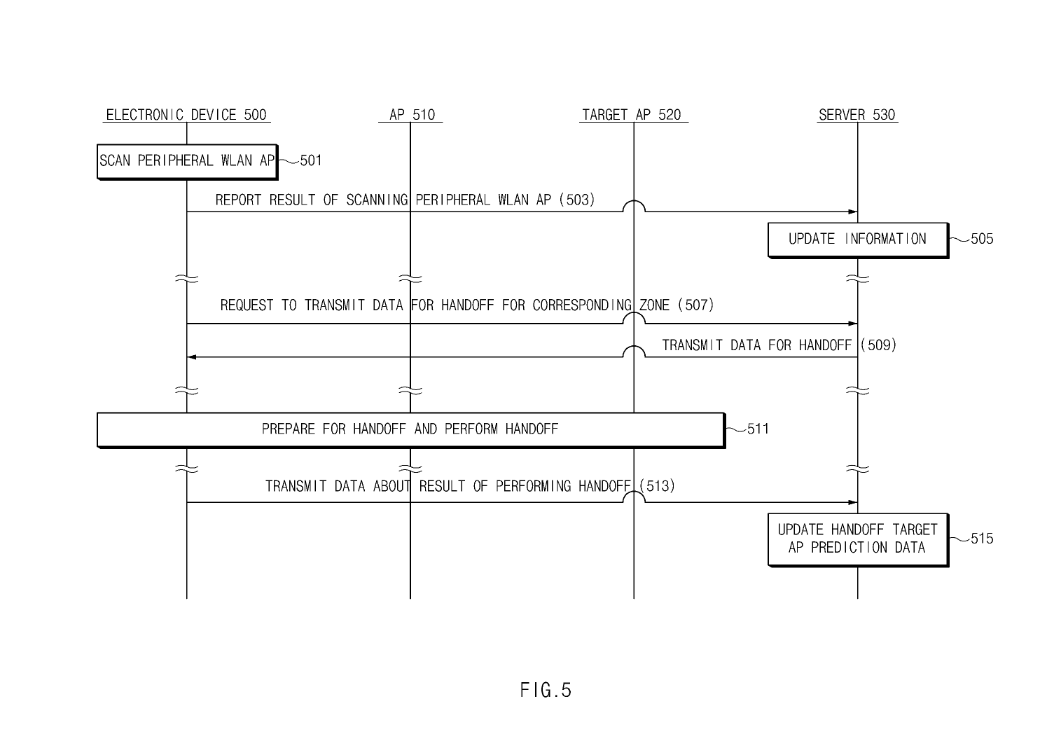

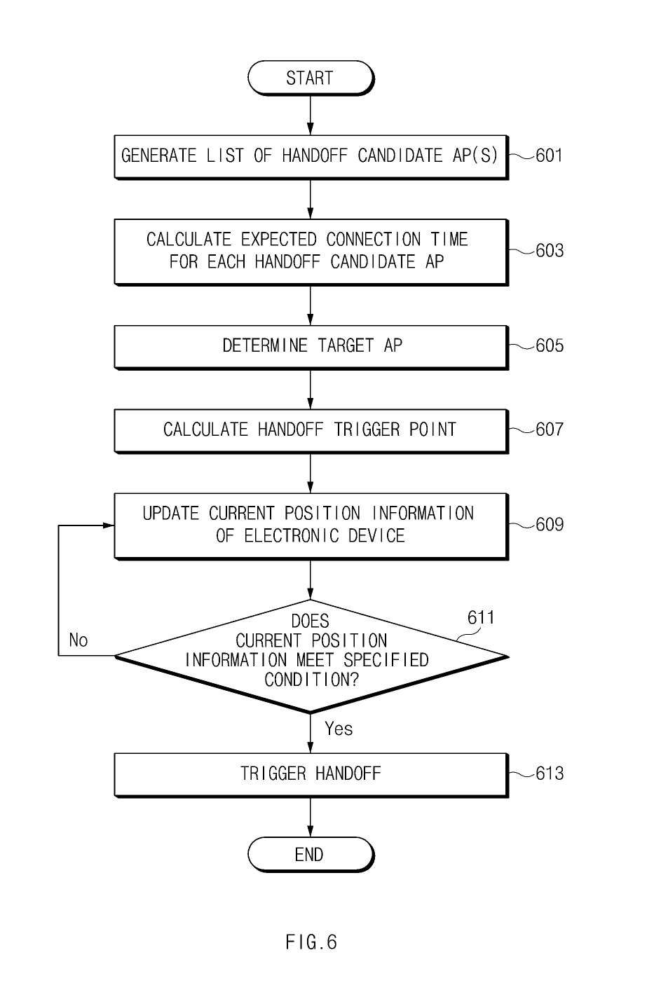

The server may in advance calculate and manage a moving direction probability at a further intersection for each zone. If the electronic device requests the server to transmit the data, it may immediately receive moving direction probability data. The electronic device in advance may request the server to transmit data for a zone around the electronic device before a handoff. The electronic device may predict a handoff target AP using the data received from the server. A handoff preparation operation of the electronic device may refer to a description below regarding FIGS. 5 and 6.

1-2-3-2. Data for Calculating a Handoff Trigger Point

Information about a channel model for calculating a handoff trigger point to a handoff target AP may be developed based on data transmitted to the server at the electronic device by collecting an RSSI of a WLAN AP around the electronic device at the electronic device. The server may apply a model according to the related art to a pathloss model or may develop a new pathloss model. For example, the server may select a proper model among conventional pathloss models by applying a linear regression method to RSSI measurement data collected from electronic devices. The server may calculate an average and standard deviation of shadowing modeled as a log normal distribution and fading by a multipath together with a pathloss model.

As such, the server may manage the application channel model information for each AP. The server may manage an index of a pathloss model, a parameter value of the model, and an average and standard deviation of log normal random variables. If the amount of newly collected data is greater than the update reference value, the server may update the channel information. If there is a request from the electronic device, the server may transmit information for a handoff, including channel information. In an embodiment of the present disclosure, if receiving in advance road information for a corresponding zone and information of APs, the electronic device may receive channel information applied to each AP together.

If it is necessary for a handoff, the electronic device may request information for the handoff in advance.

(3) Handoff Progress Procedure

2-1. Method for Transmitting and Receiving Data Between an Electronic Device and a Server

FIG. 5 is a signal sequence diagram illustrating a method for obtaining data for a handoff of an electronic device according to an embodiment of the present disclosure.

An electronic device 500 of FIG. 5 may be in a state where it is connected to an AP 510. The electronic device 500 may transmit or receive a signal with a server 530 via a AP 510.

In operation 501, the electronic device 500 may scan a peripheral WLAN AP around the electronic device 500.

In operation 503, the electronic device 500 may report the result of scanning the peripheral WLAN AP to the server 530. The electronic device 500 may transmit RSSI measurement data to the server 530. In operation 505, the server 530 may update stored information based on the result. The server 530 may manage and update data for a handoff for a corresponding zone.

In operation 507, the electronic device 500 may request to the server 530 to transmit the data for the handoff for the zone. In operation 509, the server 530 may transmit the data for the handoff to the electronic device 500. In an embodiment of the present disclosure, the data for the handoff may be data for predicting a handoff target AP and/or data for calculating a handoff point. The data for the handoff may include at least one of road information (e.g., a road type, a position, an azimuth angle, the number of lanes, a movable direction, zone division information, or the like), WLAN AP information (e.g., a BSSID, an IP address, an operation channel, and a position (e.g., a GPS coordinate)), application channel model information (e.g., a pathloss model index, a pathloss parameter value, and an average and standard deviation of log normal random variables), a lane change probability between two adjacent zones, or a moving direction probability at a per-lane intersection.

In operation 511, the electronic device 500 may prepare for a handoff and may perform the handoff. In an embodiment of the present disclosure, preparing for the handoff and performing the handoff may refer to a description with reference to FIG. 6. If the handoff is completed, the electronic device 500 may be connected to a target AP 520. The electronic device 500 may transmit or receive a signal with the server 530 via the target AP 520.

In operation 513, the electronic device 500 may transmit data about the result of performing the handoff to the server 530. In operation 515, the server 530 may update the data for the handoff. In an embodiment of the present disclosure, the server 530 may update data for predicting a handoff target AP.

Hereinafter, a description will be given in detail of each operation.

In operation 507, the electronic device 500 may obtain the data necessary for the handoff. Considering a movement speed of the electronic device 500, a time when the electronic device 500 stays within range of a WLAN AP 510 may be short. For example, if the electronic device 500 moves at a maximum driving speed of 60 km/h, the electronic device 500 may stay for about 6 seconds in range of a WLAN AP that has a service area of a radius of 100 m. Thus, it may be efficient for the electronic device 500 to receive data within a specific distance radius (e.g., L km) with respect to a current position of the electronic device 500 from the server 530 using a GPS which may be continuously measured, rather than requesting necessary data whenever the electronic device 500 attempts to perform a handoff.

If a current position of the electronic device 500 is changed to a constant range (e.g., L−q km, 0<q<L) or more due to movement of the electronic device 500, the electronic device 500 may update the received data with respect to a new current position. If using the L-q km after receiving valid data within the radius L km with respect to a position, the electronic device 500 may receive data within the radius L km again with respect to a changed current position.

The electronic device 500 may obtain data according an embodiment of the present disclosure as described below.

i) The electronic device 500 may transmit current position information (e.g., a GPS coordinate) of the electronic device 500 to the server 530.

ii) The server 530 may transmit data within the radius L km based on a current position (e.g., a GPS position) of the electronic device 500. The data within the radius L km may include fixed data, which is provided from an operator who operates a WLAN network and is stored in the server 530 in advance, and/or data transmitted from the server 530 to the electronic device 500.

iii) The electronic device 500 may perform i) again if it is determined that the electronic device 500 uses the L-q km with respect to a position (e.g., a position determined by a GPS).

In operation 511, the electronic device 500 may select a handoff target AP based on information received from the server 530, may prepare for the handoff in which a handoff point is predicted, and may perform the handoff. Hereinafter, with reference to FIG. 6, a description will be given of the operation of preparing for the handoff and performing the handoff.

2-2. Handoff Progress Procedure

FIG. 6 is a flowchart illustrating a method for performing a handoff in an electronic device according to an embodiment of the present disclosure.

In an embodiment of the present disclosure, a time when an electronic device starts to prepare for a handoff may be a time of simultaneously meeting

i) a time when a distance between an AP currently connected to the electronic device and the electronic device begins to be distant from each other and

ii) a time when the electronic device enters a zone subsequent to the nearest zone from the AP in connection with a progress direction of the electronic device.

In an embodiment of the present disclosure, the electronic device may calculate an expected connection time for each handoff candidate target AP based on a difference between an expected sojourn time and an average handoff operation time. The electronic device may determine an AP having the longest expected connection time as a target AP and may determine a handoff trigger point using a channel model.

In operation 601, the electronic device may generate a list of handoff candidate target APs. In an embodiment of the present disclosure, the electronic device may recognize a peripheral AP, a service area of which is overlapped with an AP currently connected to the electronic device, as a handoff candidate target AP. The electronic device may determine whether a service area is overlapped, using signal information which is predefined by the WLAN network operator, or is measured and obtained in advance by other electronic devices.

In operation 603, the electronic device may calculate an expected connection time for each handoff candidate target AP. If the electronic device performs a handoff to the AP with respect to each candidate target AP, it may calculate how long a connection may be maintained. A method for calculating the expected connection time may refer to a method described below.

In operation 605, the electronic device may determine a specific AP among candidate target APs as a target AP. In an embodiment of the present disclosure, the target AP may be an AP having the longest expected connection time.

In operation 607, the electronic device may calculate a handoff trigger point. The electronic device may calculate a handoff trigger point to the target AP based on data for a handoff.

In operation 609, the electronic device may update the calculated current context information of the electronic device. In an embodiment of the present disclosure, the context information may be position information.

In operation 611, the electronic device may determine whether current position information meets a specified condition. The electronic device may calculate the handoff trigger condition based on the channel model information. The handoff trigger condition may be, for example, a handoff trigger point. If a current position meets a trigger point determined based on the channel model information, in operation 613, the electronic device may trigger a handoff.

If the current position does not meet the trigger point determined based on the channel model information, the electronic device may perform operation 609.

In an embodiment of the present disclosure, if the electronic device does not progress to an expected path after operations 601 to 611, it may start to prepare for a handoff again. For example, the electronic device may start to prepare for the handoff again at a time when detecting that it does not move along a moving path of a zone served by a selected handoff target AP among the expected moving paths at an intersection based on road position information and/or GPS information. Herein, a description will be given in detail of a method for determining a target AP and a method for determining a handoff trigger point.

2-2-1. Determining a Target AP

2-2-1-1. Calculating an Expected Sojourn Time \tilde{T}ₛ(a,x)

In an embodiment of the present disclosure, the electronic device may calculate an expected connection time in operation 603 thereafter.

The electronic device may calculate an expected connection time with respect to a candidate target AP. The expected connection time may be calculated based on a time until the electronic device performs a handoff from an AP currently connected to the electronic device to a candidate target AP, a time when the electronic device performs a handoff, and/or a time taken to depart from a service area of the candidate target AP after the handoff. The electronic device may determine the expected connection time with respect to a current position. The expected connection time may be an expected time for how long the electronic device will be connected to the current AP and a handoff target AP, before and after the handoff.

Since a traffic transmission suspension time period according to performance of a handoff of the electronic device is shorter as the expected connection time is longer, the expected connection time may be used as one important element in determining a handoff target AP.

The expected connection time may be defined as a difference between an expected sojourn time when the electronic device stays in a service area of an AP connected at a current position of the electronic device and a target AP and, an average handoff operation time, like Equation (8) below.

expected connection time=expected sojourn time−average handoff operation time (8)

The electronic device may directly obtain the average handoff operation time from data received from the server. The electronic device may estimate an expected sojourn time in a service area of two APs.

The electronic device may estimate the expected sojourn time in the service area of the two APs based on an AP position in obtained data, road information, and/or a current speed. Herein, \tilde{T}ₛ(a,x) may be defined as the expected sojourn time in the service area of the two APs.

Hereinafter, x may be defined as a current position of the electronic device, and A(x) may be defined as a set of current handoff candidate target APs. Each peripheral AP may be defined as a(a∈A(x)). A(x) may be a set of peripheral APs, which are on an expected driving path, service areas are overlapped with a current AP â.

If there are n(x) moving directions (e.g., a left turn, going straight, and a right turn) at an intersection of a corresponding road based on a current position x, d_{a,i}(x) may be defined as an expected elapsed distance including a service area of a peripheral AP a with respect to an i^{th} direction. Herein, the expected elapsed distance including the service area of the peripheral AP a may mean a length of an expected distance where the electronic device will pass until the electronic device departs from a service area of the current AP â and the handoff candidate target AP a at a current position when selecting a path of a corresponding direction.

Dₐ(x) may be defined as a set of expected elapsed distances for a drivable direction including the service area of the current AP a and the handoff candidate target AP a. Dₐ(x) may be represented as {d_{a,1}(x), d_{a,2}(x), . . . d_{a,n(x)}(x)}. Pr(δ=i|x) may be defined as a probability that a user device, a current position of which is x, will select an i^{th} moving direction.

The electronic device may separately calculate an expected elapsed distance d_{a,i}(x) according to whether there is a curved road based on position information obtained for the electronic device, previously obtained road information (e.g., a position, a list of curved point coordinates, or the like), and information (e.g., a position or a radius) about a handoff candidate target AP.

d̅ₐ̅(̅x̅)̅ may be defined as an expected value of an expected elapsed distance for n(x) movable directions. d̅ₐ̅(̅x̅)̅ may be calculated based on Equation (9) below.

$$\overline{{d}_{a} ( x )} = {\sum }_{i = 1}^{n ( x )} {d}_{a , i} ( x ) \cdot Pr ( δ = i \vert x ) \qquad ( 9 )$$

If a current position of the electronic device is x, \tilde{T}ₛ(a,x), it may indicate an expected sojourn time for a candidate target AP a (a∈A(x)). If a current moving speed is v, \tilde{T}ₛ(a,x), it may be calculated based on Equation (10) below.

$${\tilde{T}}_{s} ( a , x ) := \frac{\overline{{d}_{a} ( x )}}{V} \qquad ( 10 )$$

The electronic device may calculate an expected sojourn time for a candidate target AP based on the above-mentioned embodiment of the present disclosure. A movement probability may refer to 2-2-1-4 described below.

2-2-1-2. Obtaining an Average Handoff Operation Time

$$\underline{\tilde{g} ( \hat{a} , a )}$$

A time when the electronic device performs a handoff between the current AP â and the handoff candidate target AP a may vary depending on a situation. For example, a time when an L2 handoff is performed and a time when an L3 handoff is performed may differ from each other. The server may manage average handoff operation time data between two APs, to which a handoff may be performed, using the result of performing the handoff, reported from the electronic device. The electronic device may obtain an average handoff operation time \tilde{g}(â,a) from the server. The electronic device may obtain \tilde{g}(â,a) long before a handoff is performed. The electronic device may calculate an expected connection time using \tilde{g}(â,a).

2-2-1-3. Calculating an Expected Connection Time and Determining a Target AP

\tilde{T}ₛ(a,x)−\tilde{g}(â,a) may be an expected connection time between the current AP â and the handoff candidate target AP a. In an embodiment of the present disclosure, the electronic device may select an optimum handoff target AP among APs which belong to A(x). The electronic device may select an AP a* with the longest expected connection time among APs which belong to A(x) as a handoff target AP like Equation (11) below to extend a valid connection time in which data may be transmitted and received.

$${a}^{*} = arg {max}_{a ∈ A ( x )} [ {\tilde{T}}_{s} ( a , x ) - \tilde{g} ( \hat{a} , a ) ] \qquad ( 11 )$$

Since an expected connection time for peripheral APs or a handoff candidate target AP around the electronic device is determined based on road information previously obtained by the electronic device, position information of an installed WLAN AP, and an average handoff operation time, the electronic device may fail to perform separate communication with the server at a time when it performs a handoff.

Considering a position and a progress direction of the electronic device, a calculation time taken may be reduced because there are fewer peripheral APs to be calculated. Since calculation for determining a target AP is performed in advance before starting a handoff, a time taken for the calculation may fail to have a direct influence on performing a handoff.

2-2-1-4. Calculating a Movement Probability Pr(δ=i|x)

The electronic device may calculate a probability Pr(δ=i|x) to progress in an i^{th} moving direction. In an embodiment of the present disclosure, the electronic device may move pursuant to a traffic law at an intersection while driving on a road. The electronic device may comply with a rule to make a turn along a rightmost lane for a right turn and along a leftmost lane for a left turn. The electronic device tends to change lanes in advance in preparing to go in a forward moving direction as it is closer to an intersection. As the electronic device which is being driven is closer to the intersection, driving lane information about a current position may better reflect a forward moving direction.

The electronic device which is located in a third lane may move to a third lane in zone 3, a second lane in zone 2, and a first lane in zone 1 to make a left turn, or may move to a second lane in zone 3, a first lane in zone 2, and a first lane in zone 1. Herein, classification of a zone may refer to a description about a zone disclosed with reference to FIG. 7.

The electronic device may calculate a probability Pr(δ=i|x) to progress in an i^{th} moving direction using a per-zone movement probability Pr(lₘ₋₁|lₘ) received from the server and a moving direction probability Pr(δ|l₁) according to a lane on zone 1.

When a current position x belongs to a first lane of zone 3, the electronic device may calculate a left-turn probability at an intersection like Equation (12) below. lₘ may be a random variable indicating a lane in zone m, and l(x) and z(x) may indicate a region and a lane of position x, respectively.

Pr(δ=lef|tx)=ΣₖΣⱼPr(δ=lef|tl₁=k)·Pr(l₁=k|l₂=j)·Pr(l₂=j|z(x)=3, l(x)=1) (12)

As described above, the electronic device may calculate probabilities for all progress enabled directions and may predict a direction with the highest probability as a moving direction.

2-2-2. Determining a Reference Value Associated with a Handoff Trigger Point

In operation 607, the electronic device may calculate the handoff trigger point. The electronic device may calculate a handoff trigger point for a handoff target AP a* using a channel model based on WLAN signal map data. The electronic device may calculate an optimum point for determining a handoff trigger point using channel model information of the target AP a* which was developed and transmitted from the server.

For example, it may be assumed that the electronic device obtains pathloss index 5 and values of parameter φ and v in FIG. 9, and an average and standard deviation of log normal random probabilities G modeling shadowing and/or multipath fading from the server. In this case, a position of the handoff target AP a* may be defined as r_{a*}. A separation distance between a position y of the electronic device and the target AP a* may be defined as ∥r_{a*}−y∥. ε may be defined as a threshold value of a predetermined outage probability, and pₜₕ may be defined as a minimum threshold value of receiver sensitivity of a receiver which may perform a handoff. For example, ε may be 0.05, and pₜₕ may be −83 dBm. The electronic device may have previously estimated a point y which may be connected with an AP in view of signal receive quality using Equation 13 below. In an embodiment of the present disclosure, the electronic device may calculate the connectable point y only one time at a time of determining a target AP using Equation (13) below.

Pr(P_{T}ϕ∥r_{a*}−y∥^{-v}G≥pₜₕ)≥1−ε (13)

Pr(x) may be a probability that x will occur, P_{T} may be a transmit power, φ and G may be parameters associated with the channel model, r_{a*} may be a position of the target AP, y may be a position of the electronic device, v may be a moving speed of the electronic device, pₜₕ may be the receiver sensitivity which may perform a handoff, and ε may be a threshold value of a predetermined outage probability.

The electronic device may receive a better than average service when it is closer to the handoff target AP a* than the AP â at position y. The electronic device may calculate a point \tilde{y}*with the longest distance from the AP a* while simultaneously meeting Equations (13) and (14). Herein, \tilde{y}*may be a handoff trigger point or an optimum point for handoff trigger.

∥ra*−y∥≤∥r_{â}−y∥ (14)

If the electronic device previously determines a handoff trigger point as a specific position, it may fail to pass the position due to a lane change. Thus, it is insufficient to specify the handoff trigger point as the specific point. In an embodiment, the electronic device may calculate \tilde{y}*and may define \tilde{d}*like Equation (15) below.

\tilde{d}*:=∥r_{a*}−\tilde{y}*∥ (15)

\tilde{y}*may be only calculated for obtaining \tilde{d}*. The electronic device may determine a handoff trigger point using \tilde{d}*irrespective of \tilde{y}*. Hereinafter, \tilde{d}*may be referred to as a reference value or a distance value associated with a handoff trigger point.

2-2-3. Determining a Handoff Trigger Point

In operation 609, the electronic device may update the current position information. If the current position information meets the specified condition in operation 611, in operation 613, the electronic device may trigger a handoff. In an embodiment of the present disclosure, the specified condition may be if a distance between the electronic device and the AP â is greater than \tilde{d}*and if a distance from the handoff target AP a* is less than \tilde{d}*. The electronic device may determine whether the distance between the electronic device and the AP â is greater than \tilde{d}*and simultaneously whether the distance from the handoff target AP a* is less than \tilde{d}*. The electronic device may trigger a handoff to an operation channel of the target AP a* at a position meeting the specified condition. The position meeting the specified condition may be referred to as a handoff trigger point.

2-2-4. Transmitting the Result of Performing a Handoff and Updating Data

If successfully completing a handoff, the electronic device may store the result of performing the handoff. The result of performing the handoff may include at least one of a lane change history, a time taken to perform the handoff, a moving direction at the time of the handoff, and information about a WLAN AP which succeeds in the handoff.

The electronic device may transmit the result of performing the handoff to the server. The electronic device may transmit the result of performing the handoff to the server via a target AP. The electronic device may transmit RSSI information of a peripheral WLAN AP around the electronic device and the result of performing the handoff to the server. As described above, the data transmitted to the server may be accumulated and may be used when another electronic device performs a handoff.

FIG. 7 illustrates a road region according to an embodiment of the present disclosure.

Road zone information may be a concept used to predict a moving direction based on a moving path of a vehicle. Referring to FIG. 7, a road may be classified into intervals, each having length d_{z}, according to a separation distance from an intersection, and each of the intervals may be defined as one zone. If a distance separated from an intersection is b, a zone 1 701 may be defined as a zone which is 0<b<d_{z}, and a zone 2 702 may be defined as a zone which is d_{z}<b≤2d_{z}. Zone n_{z} may be defined as a zone which is (n_{z}−1)<b≤n_{z}d_{z}.

In an embodiment of the present disclosure, an electronic device may obtain a lane movement result for the zone 1 701 at position A′. The electronic device may obtain a lane movement result for the zone 2 702 at position A.

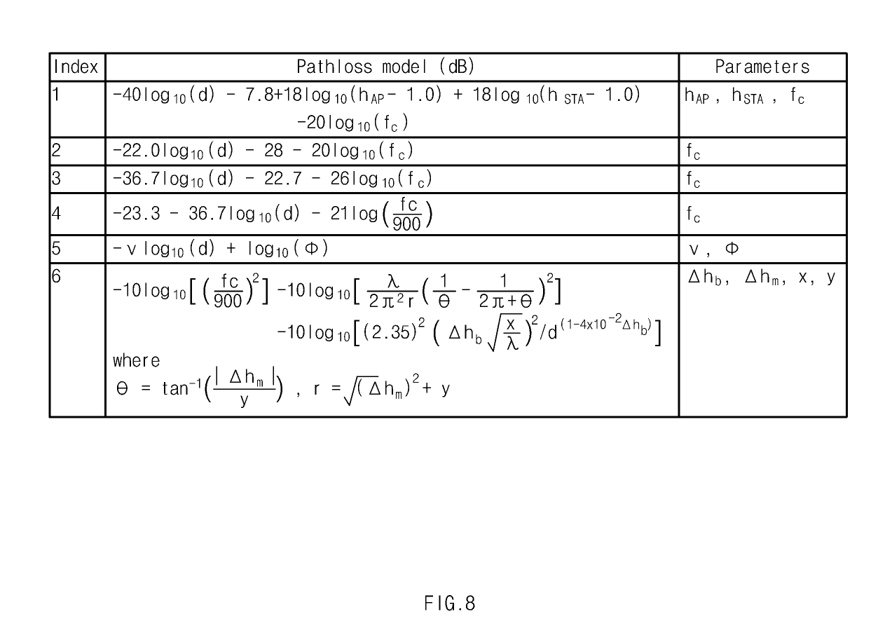

FIG. 8 is a table illustrating a pathloss model applicable to an embodiment of the present disclosure. A pathloss model shown in FIG. 8 is an example for helping understand a channel model described in the present disclosure. In addition, various channel models or pathloss models may be applied to various embodiments of the present disclosure.

A server may perform statistics processing on collected data and may select a suitable model among various channel models. For example, assuming that channel fading is determined by three elements such as pathloss, shadowing, and multipath padding, the shadowing and the channel fading by a multipath may be best modeled by a log normal random variable.

In various embodiments of the present disclosure, a log normal distribution may be a shadowing and a joint probability distribution. Various pathloss models may be applied according to a distance between an electronic device and an AP.

Referring to FIG. 8, each pathloss model may have a unique parameter. The server may indicate each pathloss model using an index and unique parameter values. The server which has RSSI measurement data from a specific AP may statistically calculate and manage a pathloss model to be applied to a specific AP, a parameter value for the model, and an average and standard deviation of a log normal distribution modeling fading.

When receiving a request from an electronic device and transmitting information of peripheral APs around the electronic device, the server may transmit channel model information applied to a signal for each AP together. Herein, the channel model information may be at least one of a pathloss model index, a related parameter value, and an average and standard deviation of a log normal distribution.

If a channel model of the specific AP is modeled as a model corresponding to pathloss index 1, the server may transmit index 1, a central frequency of the specific AP channel, an antenna height of a specific AP, and an average and standard deviation of a log normal distribution. If a pathloss model suitable for the specific AP is changed to a model corresponding to index 4 due to a change of an environment and the like, the server may transmit index 4, a central frequency, and an average and/or standard deviation of a log normal distribution.

According to embodiments of the present disclosure, the server may obtain data from the electronic device based on crowdsourcing, and may extract and manage information useful for a handoff from the data. The electronic device may in advance calculate a handoff trigger point with a handoff target AP using valid information obtained from the server before it arrives at the handoff trigger point.

Compared with the related art which starts a handoff with respect to an RSSI of an AP currently connected to the electronic device, according to various embodiments of the present disclosure, the electronic device may in advance calculate a point located closer to the electronic device than an AP such that quality of a receive signal from the target AP will be higher than a reference value. Thus, the electronic device may maintain a better than average signal strength.

FIG. 9 illustrates a handoff effect according to an embodiment.

It may be assumed that an electronic device 900 performs a handoff from an AP 910 to a target AP 920. T_{f} may indicate a time when the electronic device 900 triggers a handoff. Left graph 931 may indicate a change of an RSSI for each time or each moving distance according to a conventional handoff procedure, and graph 933 may indicate a data rate for each time or each moving distance according to the conventional handoff procedure. Right graphs 932 and 934 may be graphs indicating an RSSI and a data rate for each time or each moving distance according to a handoff procedure according to an embodiment of the present disclosure.

According to the conventional handoff procedure, since the electronic device 900 triggers a handoff at a point where an RSSI from the AP 910 meets a predetermined threshold value (e.g., −83 dBm), for example, a point where the RSSI is lower than the predetermined threshold value, as shown in graphs 931 and 933, the RSSI and a data rate may occur at a poor point. According to the conventional handoff procedure, it may be difficult to receive a signal during a constant time due to the procedures of channel scanning and the like after the handoff is triggered.

If performing the handoff according to an embodiment of the present disclosure, the electronic device 900 may determine the handoff target AP 920 in advance and may determine the handoff trigger point T_{f} where an RSSI and a data rate are well maintained. Since it is possible for the electronic device 900 to trigger a handoff although an RSSI from the AP 910 is sufficient, as shown in graphs 932 and 934, the RSSI and a data rate may be maintained to a significant level.

The term “module” used in this disclosure may represent, for example, a unit including one or more combinations of hardware, software and firmware. The term “module” may be interchangeably used with the terms “unit”, “logic”, “logical block”, “component”, and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application specific IC (ASIC), a field programmable gate array (FPGA), and a programmable logic device for performing some operations, which are known or will be developed.

At least a part of an apparatus (e.g., modules or functions thereof) or a method (e.g., operations) according to various embodiments of the present disclosure may be, for example, implemented by instructions stored in computer-readable storage media in the form of a program module. The instruction, when executed by a processor, may cause the one or more processors to perform a function corresponding to the instruction. The computer-readable storage media, for example, may be the memory.

A computer-readable recording medium may include a hard disk, a floppy disk, a magnetic media (e.g., a magnetic tape), an optical media (e.g., a compact disc read only memory (CD-ROM) and a DVD, a magneto-optical media (e.g., a floptical disk)), and memory devices (e.g., a read only memory (ROM), a random access memory (RAM), or a flash memory). Also, a program instruction may include not only assembly code that are generated by a compiler but also may be high-level language code executable on a computer using an interpreter. The above hardware unit may be configured to operate via one or more software modules for performing an operation, and vice versa.

A module or a program module according to various embodiments of the present disclosure may include at least one of the above elements, or a part of the above elements may be omitted, or additional other elements may be further included. Operations performed by a module, a program module, or other elements according to various embodiments may be executed sequentially, in parallel, repeatedly, or in a heuristic method. In addition, some operations may be executed in different sequences or may be omitted. Alternatively, other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device, comprising:
a communication circuit configured to transmit and receive a signal;
a processor; and
a memory configured to be electrically connected with the processor,
wherein the processor is configured to:
allow the communication circuit to receive data for a handoff from a server;
determine a target access point (AP) to connect with after the handoff among candidate target APs based on the data for the handoff; and
determine a handoff trigger point based on the data for the handoff and trigger a handoff to the target AP if a position of the electronic device meets the determined handoff trigger point.

2. The electronic device of claim 1, wherein the data for the handoff is data generated, at the server, based on data which is previously received at the electronic device or an electronic device different from the electronic device.

3. The electronic device of claim 1, wherein the processor is further configured to:
determine an AP, a service area of which overlaps with an AP connected to the electronic device, among peripheral APs around the electronic device as the candidate target AP.

4. The electronic device of claim 1, wherein the processor is further configured to:
calculate an expected connection time in a corresponding AP for each candidate target AP; and
determine an AP with a longest expected connection time among the candidate target APs as the target AP.

5. The electronic device of claim 1, wherein the processor is further configured to:
obtain an expected sojourn time and an average handoff operation time in an AP connected to the electronic device and the candidate target APs for each candidate target AP based on the data for the handoff; and
determine an expected connection time based on the expected sojourn time and the average handoff operation time in the AP and the candidate target APs.

6. The electronic device of claim 5, wherein the processor is further configured to:
determine the expected sojourn time based on a value in which an expected value of an expected elapsed distance is divided by a current moving speed of the electronic device; and
determine the expected value of the expected elapsed distance based on:
d̅ₐ̅(̅x̅)̅=Σᵢ₌₁^{n(x)}d_{a,i}(x)·Pr(δ=i|x)
where d̅ₐ̅(̅x̅)̅ is the expected value of the expected elapsed distance, d_{a,i}(x) is an expected elapsed distance including a service area of a candidate target AP a for an i^{th} direction among n(x) moving directions associated with a current position x, and Pr(δ=i|x) is a probability that the electronic device will progress in an i^{th} moving direction.

7. The electronic device of claim 1, wherein the data for the handoff comprises channel model information of the target AP, and
wherein the handoff trigger point is determined based on the channel model information.

8. The electronic device of claim 7, wherein the handoff trigger point comprises a point where a distance between an AP and the electronic device is greater than a distance value determined based on the channel model information and where a distance between the distance value and the target AP is less than the distance value.

9. The electronic device of claim 8, wherein the distance value corresponds to a distance between a position of the target AP and a handoff trigger optimum point for the triggering, and
wherein the processor is configured to determine the handoff trigger optimum point based on:
Pr(P_{T}ϕ∥r_{a*}−y∥^{-v}G≥pₜₕ)≥1−ε
where Pr(x) is a probability that x will occur, P_{T} is a transmit power, ϕ and G are parameters associated with the channel model, r_{a*} is a position of the target AP, y is a position of the electronic device, v is a moving speed of the electronic device, pₜₕ is receiver sensitivity which is able to perform a handoff, and c is a threshold value of a predetermined outage probability.

10. The electronic device of claim 1, wherein the processor is further configured to:
perform a handoff to the target AP, and
allow the communication circuit to transmit the result of performing the handoff to the server.

11. The electronic device of claim 1, wherein the processor is further configured to allow the communication circuit to:
transmit a result of scanning a channel of a peripheral AP around the electronic device to the server; and
transmit a data request for the handoff to the server.

12. The electronic device of claim 11, wherein the processor is further configured to determine the handoff trigger point based on channel model information; and
wherein the channel model information is associated with the result of scanning the channel of the peripheral AP.

13. The electronic device of claim 1, wherein the data for the handoff comprises at least one of road information, wireless local area network (WLAN) AP information, channel model information, a lane change probability, and a moving direction probability.

14. The electronic device of claim 1, wherein the data for the handoff is data associated with a current position of the electronic device.

15. A server, comprising:
a communication circuit configured to transmit and receive a signal;
a processor; and
a storage,
wherein the processor is configured to allow the communication circuit to:
receive a result of scanning a channel for a peripheral access point (AP) around an electronic device and moving path data of the electronic device from the electronic device;
receive a data request for a handoff from the electronic device; and
transmit data for the handoff, including at least one of channel model information about the peripheral AP around the electronic device or a moving direction probability for the electronic device, to the electronic device in response to the request for the handoff.

16. The server of claim 15, wherein the processor is further configured to determine a channel model of the peripheral AP based on the result of scanning the channel of the peripheral AP around the electronic device.

17. The server of claim 16, wherein the processor is further configured to:
update channel model data including the channel model for the peripheral AP, based on the result of scanning the channel; and
update moving direction probability data including a moving direction probability for the electronic device based on the moving path data.

18. The server of claim 17, wherein the processor is further configured to:
allow the communication circuit to receive a result of performing the handoff from the electronic device; and
update at least one of the channel model data and the moving direction probability data based on the result of performing the handoff.

19. The server of claim 18, wherein the processor is further configured to allow the communication circuit to:
receive, from the electronic device, a data request for the handoff via a first AP connected to the electronic device; and
receive, from the electronic device, the result of performing the handoff via a second AP connected to the electronic device.

20. The server of claim 15, wherein the processor is further configured to generate data for the handoff based on data previously received from the electronic device or an electronic device different from the electronic device.
